(19) United States
(12) Patent Application Publication
(10) Pub. No.: US 2009/0305864 A1
(43) Pub. Date: Dec. 10, 2009

(54) AQUEOUS SIZING COMPOSITION FOR TREATING R-GLASS, E-GLASS, AND ECR-GLASS FIBERS

(75) Inventors: Hans-Peter Richter, Neukyhna/ OT Pohritzsch (DE); Roman Teschner, Delitzsch (DE)

Correspondence Address: LERNER GREENBERG STEMER LLP, P O BOX 2480, HOLLYWOOD, FL, 33022-2480, US

(73) Assignee: S.D.R. BIOTEC VERFAHRENSTECHNIK GMBH, Neukyhna/ OT Pohritzsch (DE)

(21) Appl. No.: 12/375,287

(22) PCT Filed: Jul. 11, 2007
(86) PCT No.: PCT/EP07/06130

§ 371 Date: Feb. 27, 2009

(30) Foreign Application Priority Data
Jul. 27, 2006 (DE) 10 2006 035 565.2

(51) Int. Cl. C03C 14/00; C08L 29/04

(52) U.S. Cl. 501/32; 524/503

(57) ABSTRACT

An aqueous sizing for treating R-glass, E-glass, and ECR-glass fibers. The sizing contains a multi-component film former, a lubricant, and an adhesive. The multi-component film former includes polyvinyl acetate, polyvinyl alcohol polyether, and polyamidoamide. An aqueous sizing for producing roving fibers includes polyvinylacetate ethylene copolymer, polyamidoamide, polyvinyl alcohol polyether mixture, polypropylene or polyethylene polytetrafluorethylene wax, a coupling agent, and water.

The present invention relates to an aqueous size for treating R-glass, E-glass, and ECR-glass fibers; more particularly, it relates to the production of roving and chopped reinforcing fibers from thermally and chemically resistant glass.

Glass fibers are sensitive to buckling and abrasion, independent of their chemical composition. Even at the early stage of fiber drawing it is therefore important to effectively protect (by applying a sizing agent) the glass fibers from the abrasive effect of glass on glass or of glass on drawing drum and thus from the risk of mechanical damage This goal is achieved by the application of a size.

The composition of the size will not only affect the degree of closeness, rigidity, hardness and/or surface qualities of the glass fiber products, but also the relevant technical processes, such as textile glass fiber drawing, coiling (coil structure), drying and further processability (weaving, cutting).

In weaving processes, the cuttability, antislip quality of the warp and weft, as well as the friction and damage of glass filaments (fiber fly, breakage) will depend on the composition of the size.

Such sizes are known to include amylaceous ones, the so-called textile sizes, and so-called plastic sizes, comprising coupling agents.

Contrary to plastic sizes, amylaceous sizes will mostly not comprise any coupling agent.

Aqueous sizes for textile glass fibers mainly comprise one or more film formers, a lubricant, a wetting agent and one or more coupling agents (coupling mediators, primers).

A film former will provide the textile glass products with the required integrity, protecting the glass filaments from mutual friction and contributing to the affinity of binders or plastic matrices and thus the resistance of the finished product (composite materials).

The film formers used so far have been amylum derivates, polymers and copolymers of vinyl acetates [EP-A-0027942] of acrylic esters, epoxy resin emulsions, epoxy polyester resins, polyurethane resins [EP-A-0137427], polyolefin resins or mixed emulsions of polyvinyl acetates and polystyrene [Jap. pat. SHO-48 (1973)-28997] of a portion of 0.1 to 12 mass percent (mass percent=weight percent).

A lubricant added to the aqueous sizes will offer the glass fiber product (such as roving) the required pliability, decreasing the mutual friction of glass fibers both during production and during subsequent treatment, including weaving. Most lubricants will affect adhesion between the glass and the binders. The lubricants so far used include, for example, greases, oils, waxes or polyalkylene amines of a quantity of 0.01 to 1.0 mass percent.

A wetting agent comprised in an aqueous size decreases surface tension of water, therefore improving filament wetting by the size. The wetting agents introduced to the size may be fatty acid-based polyamides of a quantity of 0.1 to 1.5 mass percent.

Most resins (polymers) do not have any affinity to glass. Coupling agents (primers) will create a “bridge” between glass and resin which facilitates full load transmission within the composite. Coupling agents will increase polymer adhesion on the surface of the glass. The coupling agents mainly used so far include organofunctional silanes, such as γ-aminopropyltriethoxysilane, γ-methacryloxypropyltrimethoxysilane or γ-glycidyloxypropyltrimethoxysilane, comprised in the size in a portion of 0.2 to 1.0 mass percent.

Prior to adding the silanes to the aqueous size, they are mostly hydrolyzed to silanols. The hydrolyzate solution only has limited stability and is liable to condense.

The silanols react to the reactive glass surface, forming a coupling agent layer of a thickness of approx. 5 nm covering the fiber surface like a protective film. In the beginning, this protective film is still soluble as an oligomer, but will condense to cross-linked structures later on, resulting in a siloxane

≡Si—O—Si≡.

In addition to a primer, you can also add to the sizes containing coupling agents other additives, such as antistats and/or emulgators, which have the purpose of achieving specific effects.

The present state of the art knows these other auxiliary components, such as they are described by K. L. Löwenstein—The Manufacturing Technology of Continuous Glass Fibres, Elsevier Scientific Publishing Corp. Amsterdam—Oxford N.Y., 1983.

The physical-chemical properties of glass fiber products, such as glass staple fibers, will not only depend on the size, but also on the composition of the glass. The chemical glass composition will affect the mechanical properties and adhesion quality of the glass fibers.

Irrespective of their oxidic composition, glass fibers are subject to corrosion processes which strongly deteriorate both their physical-chemical properties and the adhesion at the border between the glass fiber and the binder. Once the glass fibers make contact with water, a corrosion process is started which can be described by the following chemical reactions, in general:

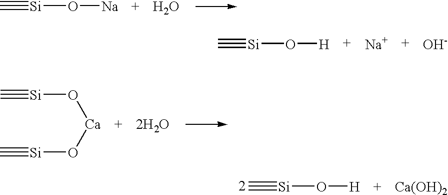

The alkaline solution released in this process, e.g. NaOH and Ca(OH)₂, attacks the sililic acid structure of the glass fibers, following the chemical process below, which can be described through the formula:

≡Si—O—Si≡+OH⁻→≡Si—O⁻+≡Si—OH

The resulting reaction products will lead to the glass fiber surface being damaged, thus particularly deteriorating fiber strength and their adhesion on the glass surface. This the reason why textile glass products, including rovings, are often manufactured from R-glass or ECR-glass (aluminum lime silicate glass) with its higher hydrolytic resistance.

The corrosion resistance of the glass fibers is particularly important when they will be used as a statically effective component in fiber concrete. The decisive feature is their alkaline and long-term resistance (measured with the so-called SIC test). All statically effective fibers which are added to concrete, are subject to a SIC strength of 500 MPa, in accordance to the DIN 1045 standard, and require the approval of the Building Board in Germany at least. For this application, it is mostly made use of alkaline-resistant glass fibers from the ECR glass (E-Glass. Corrosion Resistance) or from an R-Glass (Resistance Glass).

The glass fibers are also used for reducing the cracks due to shrinkage in cement floors. These floor fibers are used to prevent early cracks due to shrinkage in “fresh” and “young” cement floors until setting.

In Germany, no approval from the Building Board or any other approval is required for screed issues. The glass fibers used may however not affect the properties of fresh or hardened concrete. The fibers should moreover have the required granular flotation when they are worked into the cement floor in order to ensure uniform distribution. For these purposes, both the C-glass and E-glass fibers which were coated with an alkaline-resistant size, and the more expensive R-glass and ECR-glass fibers have been used.

It is the goal of the present invention to provide R-glass, E-glass and ECR-glass fibers of a high chemical resistance, which is provided by an appropriate size, significantly improving both the treatment of said glass fibers and their physical-chemical properties. The chemically resistant size according to the invention is also intended to provide the web roving with excellent processing features, such as in particular integrity, cuttability, gliding and antislip qualities. The size should have an excellent alkaline resistance for its use in cement floors as chopped, statically effective glass fibers, or for its purpose as a component reducing cracks due to shrinkage. It is also important to provide the glass fibers with a high degree of granular flotation when it comes to screeds and the reinforcement of concrete.

This requirement of the invention is met with an aqueous size which has the characteristics of Claim 1.

The treatment of R-glass, E-glass and ECR-glass fibers with the size according to the invention will have the success that their corrodibility, especially that of alkaline corrodents, is drastically reduced. This will prevent glass fiber corrosion processes and all disadvantages going along with it affecting the physical-chemical stability of the glass fibers, particularly in the alkaline environment of cement screeds or concrete. It was surprising to see that the size according to the invention provides warp and weft in weaving procedures with excellent gliding and at the same time antislip properties. It was also evident that the aqueous size according to the invention will only need some film formers, one lubricant and only one coupling agent as its components. It also came as a surprise that no other size components, such as wetting agents, antistats, emulgators, stabilizers and such were apparently needed. This will consequently simplify and rationalize the production of the sizes according to the invention. Such a simplification will regularly bring significant cost advantages within the scope of industrial series production.

The sub-claims refer to some of the characteristics of the solution, but not limiting them in any way.

The invention preferably provides for the multicomponent film former comprising one polyvinyl acetate ethylene dispersion, one polyamidoamide and/or one polyvinyl alcohol polyether. The size according to the invention also comprises, as a lubricant, a polypropylene, a polyethylene-polytetrafluorethylene or a polytetrafluorethylen wax, and a silane coupling agent which becomes active as silanol after hydrolysis.

In addition to the said reduction of the corrodibility of the glass fibers, the aqueous size according to the invention is, as a result of these components, excellently suited for being bundled, which especially facilitates the production of roving fibers. A great number of studies and tests have confirmed that roving fibers which were produced, dried and chopped according to the invention were marked by excellent granular flotation. Moreover, no negative influences on the properties of concrete or screed concrete were determined.

The roving samples exposed to hot water (at approx. 80° C.) for a period of 96 hours did not show any significant changes to the glass fiber surface indicating corrosion effects. The so-called SIC strength determined for the fibers for concrete and screed reinforcement amounted to approx. 550 MPa. In addition to the vital improvement of corrosion-resistance, in particular relating to alkaline resistance, the size according to the invention ensures an excellent protection against buckling and abrasion, providing the roving fibers with good pliability.

It has evidently been particularly advantageous to introduce the silane coupling agent to the size either as γ-aminopropyltriethoxysilane or as γ-methacryloxypropyltrimethoxysilane. These coupling agents are already generally known as primers.

To adjust the pH value, acetic acid is added to the aqueous size.

It has evidently been particularly advantageous that the size comprise, converted to solid-state concentration, approx. 2.0 to 3.0 weight percent of the multicomponent film former, approx. 0.1 to 0.2 weight percent of lubricant, and approx. 0.4 to 0.6 weight percent of coupling agent. Using these component quantities in such a proportion of ingredients, all positive qualities of the size according to the invention and the fibers produced with it will be particularly distinct. A particular observation was that roving fibers made of R and ECR glass which could be used for concrete reinforcement, were hardly subject to corrosion, thus keeping their original physical-chemical properties to an almost unchanged extent.

The web roving produced with the size according to the invention has also surprised by its excellent integrity and outstanding smoothness and cuttability of the entire thread.

The invention furthermore relates to the roving fibers coated with the above size, as well as the products manufactured from them, such as chopped fibers which are used for reinforcing purposes (fiber concrete) and/or reduction of cracks due to shrinkage in cement screeds.

The procedure of treating the fibers with the size according to the invention includes its application to the glass fiber surface, removal of exceeding size, and the thermal treatment of the coated glass fibers. The glass fibers (ropes) can now be chopped. The aqueous size according to the invention is applied using a normal spray nozzle or a galette (godet wheel, applicator). Excess size is removed, and the sized fibers are dried within the scope of thermal treatment.

It has evidently been particularly advantageous that the thermal treatment is carried out in a range of temperatures between 110° C. and 170° C. This drying process is performed in a high-frequency drier, in an electrically heated conventional compartment drier, or a microwave drier.

The final cutting, if any, of the dried roving is by means of a direct chopper.

It has been apparent that the size content, in relation to the fibers, is, by particular preference, approx. 0.4 to 1.0 weight percent. Such size content is liable to ensure excellent protection of the glass fibers against corrosion, buckling and abrasion. This will also provide for both the excellent bundling properties of the drawn glass fibers (filaments) and outstanding granular flotation of the dried and chopped roving fibers.

The invention also relates to an aqueous size for the production of roving fibers, consisting of approx.:
a) 2.0-4.0 wt. % Polyvinyl acetate ethylene copolymer
b) 0.3-0.7 wt. % Polyamidoamide
c) 0.1-0.3 wt. % Polyvinyl alcohol polyether mixture
d) 0.1-0.3 wt. % Polypropylene or polyethylene polytrafluorethylene wax
e) 0.4-0.7 wt. % Coupling agent, and
f) Water (as the balance to 100 wt. %).

The following examples are illustrative of the present invention and are not to be construed as limiting.

The origin or a manufacturer (references) of each of the components used are given in brackets.

### EXAMPLE 1

### Production of an Aqueous Size According to the Invention

Size PF1 (solid-state concentration Fₖ=2.7 mass %)

| | | |
|---|---|---|
| 1. CH₃COOH (60%) ⁽¹⁾ | 0.2 | mass % |
| 2. Polyvinyl acetate ethylene dispersion (55%) ⁽²⁾ | 3.0 | mass % |
| 3. Polyamidoamide (12.5%) ⁽³⁾ | 1.6 | mass % |
| 4. Polyvinyl alcohol polyether (20%) ⁽²⁾ | 1.0 | mass % |
| 5. Polypropylene wax (30%) ⁽⁵⁾ | 0.5 | mass % |
| 6. γ-Methacryloxypropyltrimethoxysilane ⁽⁶⁾ | 0.5 | mass %, and |
| 7. Water | 93.2 | mass % |

100 kg size contains approx:

| | | |
|---|---|---|
| 1. CH₃COOH (60%) | 0.2 | kg |
| 2. Polyvinylacetate ethylene dispersion (55%) | 3.0 | kg |
| 3. Polyamidoamide (12.5%) | 1.6 | kg |
| 4. Polyvinyl alcohol polyether (20%) | 1.0 | kg |
| 5. Polypropylene wax (30%) | 0.5 | kg |
| 6. γ-Methacryloxypropyltrimethoxysilane | 0.5 | kg, and |
| 7. Water | 93.2 | kg |

Preparation formula:
1. 60 kg water+180 g CH₃COOH (60%) are used as receiver.
2. 0.5 kg γ-methacryloxypropyltrimethoxysilane (A 174)+20 g CH₃COOH (60%) are hydrolyzed with 3.5 kg hot de-ionized water.
Duration of hydrolysis is approx. 20 min.
3. Add hydrolyzate solution A 174.
4. 3.0 kg polyvinylacetate ethylene dispersion (Mowilith DM105-55%) stirred up with 10 kg water is added to the solution.
5. 1.0 kg polyvinyl alcohol polyether (Arkofil CS20-20%) is added to the preparation.
6. 1.6 kg polyamidoamide (Albonamid) is added to the mixture.
7. 0.5 kg polypropylene emulsion (30%) is added to the preparation.
8. Add the remaining water (19.7 kg)+ca. 1 g antifoaming agent [Surfynol 440⁽⁷⁾].
9. Stir up the size and determine the pH-value.

### EXAMPLE 2

Size PF2 (solid-state concentration Fₖ=2.81 mass %)

| | | |
|---|---|---|
| 1. CH₃COOH (60%) | 0.25 | mass % |
| 2. Polyvinylacetate ethylene dispersion (55%) | 3.4 | mass % |
| 3. Polyamidoamide (12.5%) | 1.4 | mass % |
| 4. Polyvinyl alcohol polyether ⁽²⁾ (20%) | 0.8 | mass % |
| 5. Polyolefine wax (35%) ⁽⁸⁾ | 0.3 | mass % |
| 6. γ-Aminopropyltriethoxysilane ⁽⁹⁾ | 0.5 | mass %, and |
| 7. Water | 93.35 | mass % |

100 kg size contains approx.:

| | | |
|---|---|---|
| 1. CH₃COOH (60%) | 0.25 | kg |
| 2. Polyvinyl acetate dispersion (60%) | 3.4 | kg |
| 3. Polyamidoamide (12.5%) | 1.4 | kg |
| 4. Polyvinyl alcohol polyether (20%) | 0.8 | kg |
| 5. Polyolefine wax (35%) | 0.3 | kg |
| 6. γ-Aminopropyltriethoxysilane | 0.5 | kg, and |
| 7. Water | 93.15 | kg |

Preparation formula:
1. 55 kg water+240 g CH₃COOH (60%) are used as receiver.
2. 0.5 kg γ-aminopropyltriethoxysilane (A 1100) is hydrolyzed with 4.0 kg cold deionized water+10 g CH₃COOH (60%).
Duration of hydrolysis is approx. 20 min.
3. Add the hydrolyzate solution A 1100.
4. 3.4 kg polyvinyl acetate ethylene dispersion (Mowilith DM105-55%) stirred up with 10 kg water is added to the preparation.
5. 0.8 kg polyvinyl alcohol polyether (Arkofil CS20-20%) is added to the preparation.
6. 1.4 kg polyamidoamide (Albonamid) is added to the preparation.
7. 0.3 kg polyolefine wax emulsion (Michem 42035-35%) is added to the preparation.
8. Add the remaining water (24.35 kg)+approx. 1 g antifoaming agent [Surfynol 440⁽⁷⁾].
10. Stir up the size and determine the pH-value.

### EXAMPLE 3

### Production of an Aqueous Size According to the Invention

Size PF3 (solid-state concentration Fₖ=2.84 mass %)

| | | |
|---|---|---|
| 1. CH₃COOH (60%) ⁽¹⁾ | 0.2 | mass % |
| 2. Polyvinyl acetate ethylene dispersion (55%) ⁽²⁾ | 2.8 | mass % |
| 3. Polyamidoamide (12.5%) ⁽³⁾ | 2.0 | mass % |
| 4. Polyvinyl alcohol polyether ⁽²⁾ (20%) | 2.0 | mass % |
| 5. Polytetrafluorethylene wax (30%) ⁽⁹⁾ | 0.5 | mass % |
| 6. γ-Methacryloxypropyltrimethoxysilane ⁽⁶⁾ | 0.5 | mass %, and |
| 7. Water | 92.0 | mass % |

100 kg size contains approx.:

| | | |
|---|---|---|
| 1. CH₃COOH (60%) | 0.25 | kg |
| 2. Polyvinylacetate ethylene dispersion (55%) | 2.8 | kg |
| 3. Polyamidoamide (12.5%) | 2.0 | kg |
| 4. Polyvinyl alcohol polyether mixture (20%) | 2.0 | kg |
| 5. Polytetrafluorethylene wax (30%) | 0.5 | kg |
| 6. γ-Methacryloxypropyltrimethoxysilane | 0.5 | kg, and |
| 7. Water | 92.0 | kg |

Preparation formula:
1. 55 kg Water+180 g CH₃COOH (60%) are used as receiver.
2. 0.5 kg γ-methacryloxypropyltrimethoxysilane (A 174)+20 g CH₃COOH (60%) is hydrolyzed with 3.5 kg hot de-ionized water.
Duration of hydrolysis is approx. 20 min.
3. Add the hydrolyzate solution A 174.
4. 2.8 kg polyvinyl acetate ethylene dispersion (Mowilith DM105-55%) stirred up with 10 kg water is added to the preparation.
5. 2.0 kg polyvinyl alcohol polyether (Arkofil CS20-20%) is added to the preparation.
6. 2.0 kg polyamidoamide (Albonamid) is added to the preparation.
7 0.5 kg PTFE wax emulsion (Lanco Glidd 9530-30%) is added to the preparation.
8. Add the remaining water (23.50 kg)+approx. 1 g antifoaming agent [Surfynol 440⁽⁷⁾].
9. Stir up the size and determine the pH-value.

### REFERENCES

| | |
|---|---|
| (1) | Brenntag-Chemiepartner |
| (2) | Clariant |
| (3) | Albon-Chemie |
| (4) | Interorgana |
| (5) | Lubrizol-Coating Additives |
| (6, 9) | Crompton Specialty |
| (7) | Wilhelm E. H. Biesterfeld |
| (8) | Michelman |
| (9) | Georg M. Langer & Co. |

1-11. (canceled)

12. An aqueous sizing composition for treating R-glass, E-glass, and ECR-glass fibers, the sizing composition comprising:
a multicomponent film former;
a lubricant; and
a coupling agent;
said multicomponent film former including:
70-85 wt. % polyvinyl acetate;
7-20 wt. % polyvinyl alcohol polyether; and
7-12 wt. % polyamidoamide.

13. The sizing composition according to claim 12, wherein said lubricant is a polyolefin wax.

14. The sizing composition according to claim 13, wherein said polyolefin wax is a wax selected from the group consisting of polypropylene wax, polyethylene-polytetrafluorethylene wax, or polytetrafluorethylene wax.

15. The sizing composition according to claim 12, wherein said coupling agent is a silane coupling agent.

16. The sizing composition according to claim 15, wherein said silane coupling agent is either a γ-methacryloxypropyltrimethoxysilane or a γ-aminopropyltriethoxysilane, each hydrolyzed to silanol.

17. The sizing composition according to claim 12, comprising, relative to a solid-state concentration, about 2.0 to 3.0 wt. % of said multicomponent film former, about 0.1 to 0.15 wt. % of said lubricant, and about 0.4 to 0.6 wt. % of said coupling agent.

18. An aqueous sizing composition for producing roving fibers, comprising:
a) 2.0-4.0 wt. % polyvinylacetate ethylene copolymer;
b) 0.3-0.7 wt. % polyamidoamide;
c) 0.1-0.3 wt. % polyvinyl alcohol polyether mixture;
d) 0.1-0.3 wt. % polypropylene or polyethylene polytetrafluorethylene wax;
e) 0.4-0.7 wt. % coupling agent; and
f) remainder water, to balance to 100 wt. %.

19. A method of treating glass fibers, which comprises providing the sizing composition according to claim 12 and treating fibers made of R-glass, E-glass, or ECR-glass with the sizing composition.

20. The method according to claim 19, which comprises applying the sizing composition at 0.5 to 1.5 wt. % relative to the glass fiber.

21. A method of forming textile glass products, which comprises providing the sizing composition according to claim 12 and forming therewith a textile glass product.

22. The method according to claim 21, which comprises forming rovings.

23. A method, comprising: providing the sizing composition according to claim 12, treating glass fibers with the sizing composition, and admixing the treated fibers into cement screeds or into concrete as statically effective fibers, containing at least a fiber made of R-glass, E-glass, or ECR-glass.
